(19) United States
(12) Patent Application Publication
(10) Pub. No.: US 2024/0421474 A1
(43) Pub. Date: Dec. 19, 2024

(54) Methods and Systems for Centimeter-accurate Localization with Carrier Phase from Asymmetric Antennas

(71) Applicant: Google LLC, Mountain View, CA (US)

(72) Inventors: Frank Stephen Tromp van Diggelen, Carmel-by-the-Sea, CA (US); Mohammed Khider, Mountain View, CA (US)

(21) Appl. No.: 18/336,363

(22) Filed: Jun. 16, 2023

(51) Int. Cl. H01Q 3/04; H01Q 1/24

(52) U.S. Cl. CPC H01Q 3/04; H01Q 1/241

(57) ABSTRACT

Example embodiments relate to centimeter-accurate localization using asymmetric antennas. A pair of mobile devices can establish a wireless communication connection with one device acting as a base station and the other being a rover for real-time kinematic (RTK) positioning. When the mobile devices have similar asymmetric antennas for Global Navigation Satellite System (GNSS) signal reception, errors caused by the asymmetric antennas can be canceled by combining measurements from both devices. The rover mobile device may display instructions for the user to adjust its orientation to align with the orientation of the base station mobile device. The rover mobile device can then obtain and use measurement or correction data from the base station to determine its position relative to the rover mobile device. Such techniques can be performed by complementary model devices to be used to map areas to a high degree of precision (e.g., centimeter level), including elevation.

### BACKGROUND

Real-Time Kinematic (RTK) is a satellite-based positioning technique that can provide highly accurate and precise positioning data. The technique is often used in surveying, mapping, precision agriculture, and other applications that require precise measurements and involves the use of a fixed base station and a mobile rover. The base station receives and uses signals from the Global Navigation Satellite Systems (GNSS), such as GPS, GLONASS, Galileo, BeiDou, or other similar system, to calculate its position and determine errors in the satellite signals caused by atmospheric conditions and other factors. The base station then sends its position and measured signals to the mobile rover, which can apply them to its own GNSS measurements to refine its positioning data in real-time.

Although RTK systems can provide accurate measurements, they are typically more expensive and complex compared to other positioning techniques. In particular, setting up and maintaining a base station, managing measurement or correction data, and ensuring reliable radio communication between the base station and the rover can require technical expertise and costs in addition to the costs of the specialized equipment serving as the base station and the rover.

### SUMMARY

Example embodiments relate to techniques for centimeter-accurate localization using asymmetric antennas. For instance, a pair of smartphones or another type of mobile computing devices with asymmetric antennas can be aligned in orientation to cancel phase-center errors when performing disclosed techniques to achieve centimeter-accurate location measurements.

Accordingly, a first example embodiment describes a method. The method involves establishing, by a first mobile computing device, a wireless communication connection with a second mobile computing device and receiving, at the first mobile computing device and from the second mobile computing device, data representing an orientation of the second mobile computing device relative to a reference point. The method also involves providing, by the first mobile computing device and on a display interface of the first mobile computing device, instructions to rotate the first mobile computing device until an orientation of the first mobile computing device matches with the orientation of the second mobile computing device. The method further involves receiving, by the first mobile computing device, a plurality of Global Navigation Satellite System (GNSS) signals and measurement data from the second mobile computing device positioned at a second location. The method also involves determining, by the first mobile computing device, a first location representing a position of the first mobile computing device relative to the second computing device based on the plurality of GNSS signals and the measurement data received from the second mobile computing device.

Another example embodiment describes a system. The system includes a first mobile computing device and a second mobile computing device. The first mobile computing device is configured to establish a wireless communication connection with a second mobile computing device and receive, from the second mobile computing device, data representing an orientation of the second mobile computing device relative to a reference point. The first mobile computing device is further configured to provide, on a display interface of the first mobile computing device, instructions to rotate the first mobile computing device until an orientation of the first mobile computing device matches with the orientation of the second mobile computing device. The first mobile computing device is also configured to receive a plurality of Global Navigation Satellite System (GNSS) signals and measurement data from the second mobile computing device positioned at a second location and determine a first location representing a position of the first mobile computing device relative to the second mobile computing device based on the plurality of GNSS signals and the measurement data received from the second mobile computing device.

An additional example embodiment describes a non-transitory computer-readable medium configured to store instructions, that when executed by a first mobile computing device, causes the first mobile computing device to perform operations. The operations involve establishing a wireless communication connection with a second mobile computing device, receiving, from the second mobile computing device, data representing an orientation of the second mobile computing device relative to a reference point, and providing, on a display interface of the first mobile computing device, instructions to rotate the first mobile computing device until an orientation of the first mobile computing device matches with the orientation of the second mobile computing device. The operations also involve receiving a plurality of Global Navigation Satellite System (GNSS) signals and measurement data from the second mobile computing device positioned at a second location and determining a first location representing a position of the first mobile computing device relative to the second mobile computing device based on the plurality of GNSS signals received by the first mobile computing device and the measurement data received from the second mobile computing device.

These as well as other aspects, advantages, and alternatives will become apparent to those of ordinary skill in the art by reading the following detailed description, with reference where appropriate to the accompanying drawings.

### BRIEF DESCRIPTION OF THE FIGURES

FIG. 1 is a simplified block-diagram of a computing system, according to one or more example embodiments.

FIG. 2 illustrates a mobile computing device determining its location using signals from a set of satellites, according to one or more example embodiments.

FIG. 3 is a flowchart of a method for determining location using asymmetric antennas, according to one or more example embodiments.

FIG. 4 is a simplified block-diagram of two mobile computing devices establishing a wireless communication connection, according to one or more example embodiments.

FIG. 5 depicts a mobile computing device displaying rotation instructions, according to one or more example embodiments.

FIG. 6 illustrates an adjustment of the orientation of the mobile computing device, according to one or more example embodiments.

FIG. 7 illustrates the mobile computing devices performing localization, according to one or more example embodiments.

FIG. 8 illustrates the mobile computing devices mapping an area, according to one or more example embodiments.

FIG. 9 is a schematic diagram of a computer program, according to one or more example embodiments.

### DETAILED DESCRIPTION

Example methods and systems are described herein. It should be understood that the words “example,” “exemplary,” and “illustrative” are used herein to mean “serving as an example, instance, or illustration.” Any implementation or feature described herein as being an “example,” being “exemplary,” or being “illustrative” is not necessarily to be construed as preferred or advantageous over other implementations or features. The example implementations described herein are not meant to be limiting. It will be readily understood that the aspects of the present disclosure, as generally described herein, and illustrated in the figures, can be arranged, substituted, combined, separated, and designed in a wide variety of different configurations, all of which are explicitly contemplated herein.

Specialized devices used to perform RTK techniques have antennas that are circular in design with radial symmetry and precise phase centers, which enables the phase measurements of received signals to be precise (e.g., within a fraction of a centimeter) regardless of the horizontal orientation of the antenna and the device in general. Smartphones and other types of mobile computing devices, however, typically have asymmetric GNSS antennas, which can result in the phase measurement of received signals to vary based on the horizontal orientation of the smartphone. In some instances, the orientation of a mobile computing device with an asymmetric antenna can influence the phase measurement of received signals by several centimeters

Example embodiments presented herein relate to localization techniques that can be performed by smartphones and other types of mobile computing devices that have complementary asymmetric antennas in order to obtain precise position measurements (e.g., centimeter-accurate positions). Such techniques enable a pair of mobile computing devices with similar asymmetric antenna configurations that produce similar phase errors to cancel out these errors by having aligned orientations during signal reception, which allows the mobile computing devices to subsequently produce accurate localization measurements similar to specialized RTK devices.

As an example, two or more mobile phones that have complementary antenna characteristics may execute an application that can coordinate the orientations of the devices and location information between the mobile phones. For instance, one phone may operate as the base station while the other phone is designated as the rover due to both devices having complementary antenna characteristics that enable phase errors to be canceled out when the phones are oriented in the same way when receiving GNSS signals. In some cases, the mobile phones can be the same type or similar models that have complementary antenna characteristics. If there are multiple phones operating as base stations, the phone serving as the rover can select one base station at a time and may default to selecting the closest base station for localization operations. In practice, while placed at a different location, the rover phone communicates with the base station phone that is placed at a reference location (e.g., a corner of a field or a previously surveyed point). At each new location of the rover, the application directs the user of the rover phone to adjust its orientation (e.g., rotate the phone) until the rover phone is aligned with the base station thereby enabling the phase errors from the asymmetric antennas to cancel out. For instance, the application may direct the rover phone to be rotated until both the rover phone and the base station phone are facing in the same direction (e.g., both facing toward geographic north). The application then reports, in real time, when accurate measurements have been produced by the devices (e.g., centimeter-level accuracy has been achieved), which occurs after RTK integer ambiguity resolution has been successfully completed. The user can then move the rover phone and repeat the process at a new location. As such, disclosed techniques enable mobile computing systems to accurately map or survey various locations, including capturing elevation differences between the mobile computing systems.

An example method involves establishing, by a first mobile computing device, a wireless communication connection with a second mobile computing device and receiving, at the first mobile computing device and from the second mobile computing device, data representing an orientation of the second mobile computing device relative to a reference point. For instance, the first mobile computing device may execute an application that coordinates a connection and communication with the second mobile computing device. The first mobile computing device may then display instructions to rotate the first mobile computing device until an orientation of the first mobile computing device matches with the orientation of the second mobile computing device and then determine a first location representing a position of the first mobile computing device relative to the second mobile computing device based on GNSS signals received by the first mobile computing device and measurement or correction data provided by the second mobile computing device positioned at a second location. For instance, the first mobile computing device can determine its distance, azimuth, and/or elevation relative to the second mobile computing device. The first mobile computing device can be repositioned to different locations and perform similar techniques to obtain updated location measurements.

In some cases, the second mobile computing device can be positioned at a previously measured location (e.g., at a survey marker). This enables the first mobile computing device to receive and use data representing an absolute location of the second mobile device to determine its own absolute location. The absolute location can specify the longitude and latitude of the first mobile computing device.

The mobile computing devices performing disclosed techniques can use various feedback techniques to instruct and alert a user or users of the mobile computing devices. For instance, a mobile computing device may provide audible, haptic, and/or text instructions that assists the user align the orientation of the mobile computing device relative to the mobile computing device serving as the base station. In some cases, the mobile computing device serving as the base station may provide instructions to the user to adjust its orientation to match the orientation of one or more rover mobile computing devices.

Systems, methods, and devices in which examples may be implemented will now be described in greater detail. In general, described methods may be implemented by various types of computing devices or components of the devices. In one example, a system may include one or more servers, which may receive information from and provide information to a device, such as a mobile phone. However, the described methods may also be implemented by other computing devices, such as a personal computer, a wearable computing device, stand-alone receiver, or a mobile device, among others. Further, an example system may take the form of a computer readable medium, which has program instructions stored thereon that are executable by a processor to provide functionality described herein. Thus, an example system may take the form of a device such as a server, or a subsystem of such a device, which includes such a computer readable medium having such program instructions stored thereon.

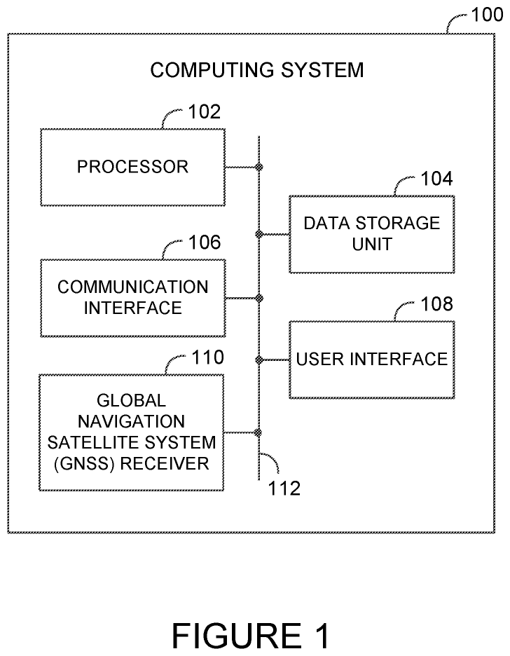

Referring now to the figures, FIG. 1 is a simplified block-diagram of computing system 100 that can perform various acts and/or functions, such as those described in this disclosure. Computing system 100 may correspond to any type of device, such as a smartphone, portable computer, or wearable computing device, etc., and can include various components, such as processor 102, data storage unit 104, communication interface 106, user interface 108, and/or GNSS receiver 110. Computing system 100 may include one or multiple asymmetric antennas.

These components as well as other possible components can connect to each other (or to another device, system, or other entity) via connection mechanism 112, which represents a mechanism that facilitates communication between two or more devices, systems, or other entities. As such, connection mechanism 112 can be a simple mechanism, such as a cable or system bus, or a relatively complex mechanism, such as a packet-based communication network (e.g., the Internet). In some instances, a connection mechanism can include a non-tangible medium (e.g., where the connection is wireless). In a further implementation, computing system 100 can include more or fewer components and may correspond to a standalone receiver configured to perform location determination processes described herein.

Processor 102 may correspond to a general-purpose processor (e.g., a microprocessor) and/or a special-purpose processor (e.g., a digital signal processor (DSP)). In some instances, computing system 100 may include a combination of processors.

Data storage unit 104 may include one or more volatile, non-volatile, removable, and/or non-removable storage components, such as magnetic, optical, or flash storage, and/or can be integrated in whole or in part with processor 102. As such, data storage unit 104 may take the form of a non-transitory computer-readable storage medium, having stored thereon program instructions (e.g., compiled or non-compiled program logic and/or machine code) that, when executed by processor 102, cause the computing system 100 to perform one or more acts and/or functions, such as those described in this disclosure. Computing system 100 can be configured to perform one or more acts and/or functions, such as those described in this disclosure. Such program instructions can define and/or be part of a discrete software application. In some instances, computing system 100 can execute program instructions in response to receiving an input, such as from communication interface 106 and/or user interface 108. Data storage unit 104 may also store other types of data, such as those types described in this disclosure.

In some examples, data storage unit 104 may store one or more maps depicting the location of potential reflecting planes in areas that computing system 100 may traverse. For instance, these maps may represent the position and elevation of buildings and other structural features. In addition, these maps may also indicate the position and elevation for physical features, such as mountains and other land masses that may interfere with signal reception. Computing system 100 may obtain the maps from an external source and store the maps in data storage unit 104.

Communication interface 106 can allow computing system 100 to connect to and/or communicate with another entity according to one or more protocols. In an example, communication interface 106 can be a wired interface, such as an Ethernet interface or a high-definition serial-digital-interface (HD-SDI). In another example, communication interface 106 can be a wireless interface, such as a cellular or WI-FI interface. A connection can be a direct connection or an indirect connection, the latter being a connection that passes through and/or traverses one or more entities, such as a router, switcher, or other network device. Likewise, a transmission can be a direct transmission or an indirect transmission.

User interface 108 can facilitate interaction between computing system 100 and a user of computing system 100, if applicable. As such, user interface 108 can include input components such as a keyboard, a keypad, a mouse, a touch sensitive panel, a microphone, and/or a camera, and/or output components such as a display device (which, for example, can be combined with a touch sensitive panel), a sound speaker, and/or a haptic feedback system. More generally, user interface 108 can include hardware and/or software components that facilitate interaction between computing system 100 and the user of the computing device system. In some examples, user interface 108 can provide audio, tactile, and/or visual communications that help guide a user through steps that enable computing system 100 to perform disclosed localization operations with assistance from one or more other computing systems.

GNSS receiver 110 represents a component that computing system 100 can use for location and velocity determination processes. In practice, GNSS receiver 110 is able to receive signals from multiple satellite constellations to determine precise positioning, velocity, and timing information and may use one or more asymmetric antennas to receive the signals. GNSS is a collective term that encompasses various satellite navigation systems, including the United States' GPS (Global Positioning System), Russia's GLONASS, China's BeiDou, Europe's Galileo, and other regional systems. As such, GNSS receiver 110 works by receiving signals from multiple satellites in orbit and calculating the time it takes for the signals to travel from the satellites to GNSS receiver 110. By knowing the precise locations of the satellites at the time of transmission, GNSS receiver 110 can determine its own position through a process called trilateration. Trilateration is similar to identifying a location on a map knowing the precise distance from three different landmarks using a pair of compasses, where the location may correspond to the point that the three circles centered on each of the landmarks overlap given that the radius of each circle corresponds to the distance from each landmark. In particular, computing system 100 can use GNSS receiver 110 to perform trilateration via a set of simultaneous equations, where each equation describes the distance to one particular satellite as a function of the receiver location. In some cases, computing system 100 can execute four or more simultaneous equations to determine its location.

In some examples, GNSS receiver 110 can incorporate multiple frequency bands and support multiple satellite constellations to improve positioning accuracy, availability, and reliability. In addition, computing system 100 and/or GNSS receiver 110 can use advanced algorithms and signal processing techniques to mitigate various sources of error, such as atmospheric interference and multipath reflections. As such, GNSS receiver 110 may enable computing system 100 or applications on computing system 100 to quickly access and use location, velocity, and direction information. In general, location may be determined in three dimensions, including altitude. GNSS receiver 110 may be configured to supplement location determination with information received via Bluetooth or Wi-Fi signals. In addition, computing system 100 can use information derived based on signals received via GNSS receiver 110 while performing disclosed localization operations in communication with another computing device serving as the rover or base station.

As indicated above, connection mechanism 112 may connect components of computing system 100. Connection mechanism 112 is illustrated as a wired connection, but wireless connections may also be used in some implementations. For example, connection mechanism 112 may be a wired serial bus such as a universal serial bus or a parallel bus. A wired connection may be a proprietary connection as well. Likewise, connection mechanism 112 may also be a wireless connection using, e.g., Bluetooth® radio technology, communication protocols described in IEEE 802.11 (including any IEEE 802.11 revisions), Cellular technology (such as GSM, CDMA, UMTS, EV-DO, WiMAX, LTE, or 5G), or Zigbee® technology, among other possibilities.

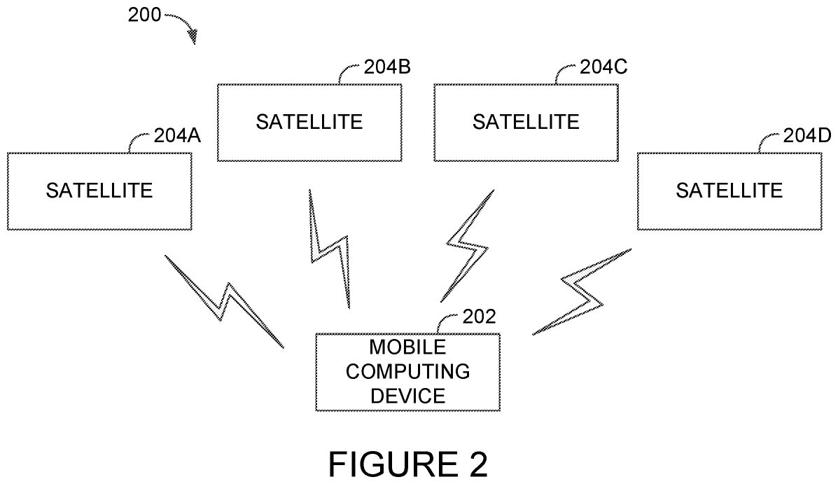

FIG. 2 illustrates mobile computing device 202 determining its location using signals from a set of satellites. Scenario 200 shown in FIG. 2 represents a general situation showing mobile computing device 202 as an example GNSS device that receives and uses signals from satellite 204A, satellite 204B, satellite 204C, and/or satellite 204D to determine its location, velocity, and/or other positional information (e.g., distance relative to a base station). Within other implementations, scenario 200 may involve more or fewer satellites and/or additional receivers.

Mobile computing device 202 may correspond to computing system 100 and/or another device with more or fewer components. For example, mobile computing device 202 may correspond to a smartphone, wearable computing device, or a vehicle GNSS system, among other possible devices. In some cases, mobile computing device 202 includes one or more asymmetric antennas that are used to receive GNSS signals from satellites 204A-204D.

Satellites 204A-204D as well as other satellites in the GNSS network may orbit Earth and periodically transmit signals having information that receivers may use for location determination. Each transmitted signal may include information that assists receivers perform location determination, such as an indication of the time that the satellite transmitted the signal towards the surface of Earth based on the satellite's atomic clock. A transmitted signal may also provide other information, such as an indication of the relationship between the satellite's clock and GPS time, or the reference time of other GNSS, and precise orbit information that helps the receiver determine a position of the transmitting satellite. As such, mobile computing device 202 as well as other receivers may receive and use the periodically transmitted signals from the set of satellites to determine location and/or other possible information, such as velocity. Reception of signals from multiple satellites (e.g., four satellites) may enable a receiver to perform location determination processes, such as the trilateration calculations described above.

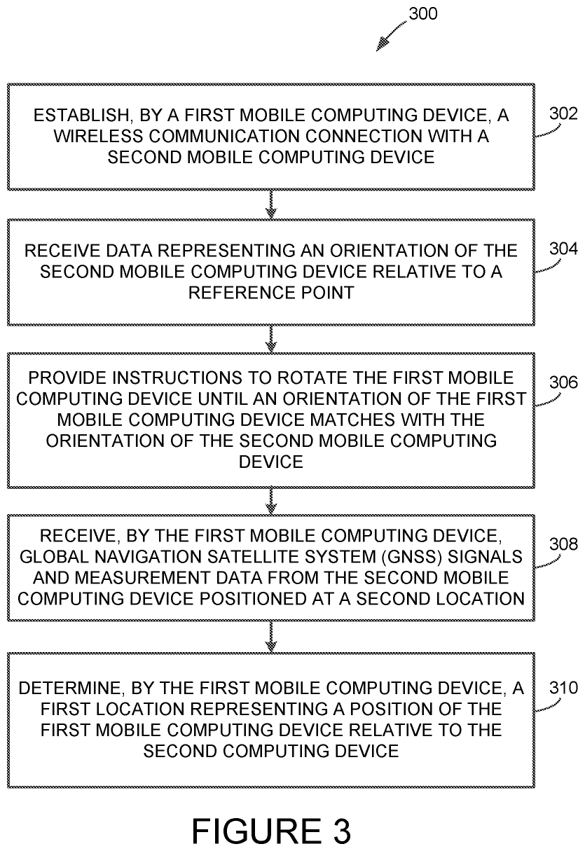

FIG. 3 is a flow chart of method 300 using carrier phase from asymmetric antennas for localization. Method 300 may include one or more operations, functions, or actions as illustrated by one or more of blocks 302, 304, 306, and 308. Although the blocks are illustrated in a sequential order, these blocks may in some instances be performed in parallel, and/or in a different order than those described herein. Also, the various blocks may be combined into fewer blocks, divided into additional blocks, and/or removed based upon the desired implementation.

In addition, for method 300 and other processes and methods disclosed herein, the flowchart shows functionality and operation of one possible implementation of present embodiments. In this regard, each block may represent a module, a segment, or a portion of program code, which includes one or more instructions executable by a processor for implementing specific logical functions or steps in the process. The program code may be stored on any type of computer readable medium or memory, for example, such as a storage device including a disk or hard drive.

The computer readable medium may include a non-transitory computer readable medium, for example, such as computer-readable media that stores data for short periods of time like register memory, processor cache and Random Access Memory (RAM). The computer readable medium may also include non-transitory media or memory, such as secondary or persistent long term storage, like read only memory (ROM), optical or magnetic disks, compact-disc read only memory (CD-ROM), for example. The computer readable media may also be any other volatile or non-volatile storage systems. The computer readable medium may be considered a computer readable storage medium, a tangible storage device, or other article of manufacture, for example. Furthermore, for method 300 and other processes and methods disclosed herein, each block in FIG. 3 may represent circuitry that is wired to perform the specific logical functions in the process.

At block 302, method 300 involves establishing, by a first mobile computing device, a wireless communication connection with a second mobile computing device. Both the first mobile computing device and the second mobile computing device include one or more asymmetric antennas configured for receiving GNSS signals. In some examples, the first mobile computing device and the second mobile computing device are complementary models of mobile computing devices. For instance, both the first mobile computing device and the second mobile computing device can be smartphones. The first mobile computing device and the second mobile computing device can have complementary antenna characteristics, which enables phase errors caused by their asymmetric antennas to be canceled out. For instance, the first and second mobile computing devices can be a particular model or similar model of smartphone. For instance, the first and second mobile computing devices can be produced by the same manufacturer. In other examples, the first and second mobile computing devices can be different types of devices and/or from different manufacturers, but with complementary antenna characteristics.

At block 304, method 300 involves receiving, at the first mobile computing device and from the second mobile computing device, data representing an orientation of the second mobile computing device relative to a reference point. For instance, the first mobile computing device may receive data that represents the orientation of the second mobile computing device relative to a geographic north direction.

Communication between the first and second mobile computing devices can occur over the established wireless communication connection. For instance, the devices may communicate over Wi-Fi, Bluetooth, Near Field Communication (NFC), or one or more cellular networks, among other options.

At block 306, method 300 involves providing, by the first mobile computing device and on a display interface of the first mobile computing device, instructions to rotate the first mobile computing device until an orientation of the first mobile computing device matches with the orientation of the second mobile computing device. The first mobile computing device can provide instructions via audio, text, visuals, haptic feedback, or a combination of options.

The first mobile computing device may determine its orientation based on sensor data from a magnetometer of the first mobile computing device. In some examples, the first mobile computing device may use an accelerometer, gyroscope, magnetometer, and/or a combination of measurements from multiple sensors. The first mobile computing device can use algorithms to calculate the device's orientation in three-dimensional space. For instance, the algorithms can combine the sensor readings to determine the phone's tilt, roll, and azimuth angles, which represent its pitch, rotation, and compass direction, respectively.

In some examples, the first mobile computing device detects when the orientation of the first mobile computing device matches the orientation of the second mobile computing device and then provides an audio, visual, or haptic alert based on detecting the orientation of the first mobile computing device matches the orientation of the second mobile computing device. The first and second mobile computing devices can communicate in real-time to ensure that orientations are matched in cases where the orientation of one of the devices is changed.

At block 308, method 300 involves receiving, by the first mobile computing device, GNSS signals and measurement data from the second mobile computing device positioned at a second location. The first mobile computing device may receive the GNSS signals and measurement data within a threshold time after the first mobile computing device determines that its own orientation matches the orientation of the second mobile computing device.

The first mobile computing device can receive the measurement data from the second mobile computing device, which is based on the second location of the second mobile computing device. The measurement data can refer to the information transmitted by the second mobile computing device to the first mobile computing device and may contain precise measurements of the errors and biases affecting the signals received from GNSS satellites. These errors can arise from atmospheric conditions, satellite orbits, clock discrepancies, and/or other factors. The second mobile computing device can collect raw GNSS data and compute the corrections by comparing the observed signals with the expected values. These corrections can then be transmitted to the first mobile computing device in real-time or near real-time. By factoring the measurement or correction data from the second mobile computing device, the first mobile computing device can improve the accuracy of its position estimation.

At block 310, method 300 involves determining, by the first mobile computing device, a first location representing a position of the first mobile computing device relative to the second computing device based on the GNSS signals and the measurement data received from the second mobile computing device. The first mobile computing device uses its one or more asymmetric antennas to receive the plurality of GNSS signals and can use the established wireless connection to obtain the measurement and/or correction data from the second mobile computing device. In some cases, the first and second mobile computing devices can communicate in-real time to factor changes in position of either device when calculating location information.

The first mobile computing device may use the signals to determine a distance, an azimuth, and an elevation of the first mobile computing device relative to the second mobile computing device. For example, the first mobile computing device can determine and display an elevation difference measured between the first mobile computing device and the second mobile computing device. As such, the first mobile computing device can determine the first location representing the position of the first mobile computing device at a precision level above a threshold accuracy level (e.g., at a centimeter-level) relative to the second location of the second mobile computing device.

In some examples, the first mobile computing device receives data representing an absolute location of the second mobile computing device. The first mobile computing device then can determine its absolute location based on the data representing the absolute location of the second mobile computing device. The determined absolute location indicates the longitude and the latitude and altitude of the first mobile computing device.

In some examples, the first mobile computing device detects a change in the position of the first mobile computing device and then determines a third location representing the position of the first mobile computing device. In particular, the first mobile computing device can determine the third location based on a second plurality of GNSS signals received by the first mobile computing device and second measurement or correction data provided by the second mobile computing device positioned at the second location. The first mobile computing device may then further estimate an area of an environment extending between the first location, the second location, and the third location.

The first mobile computing device can store the first location representing the position of the first mobile computing device relative to the second mobile computing device in addition to other measured locations. The first mobile computing device can then determine an area of an environment based on the first location and one or more additional locations representing respective positions of the first mobile computing device relative to the second mobile computing device. The first mobile computing device may then display an augmented map of the environment with an overlay representing the area of the environment. For instance, the map of the environment can accurately display the environment along with a two-dimensional or three-dimensional graphical representation of the measured area, which can convey elevation differences. In some examples, the mobile computing devices can store multiple areas in memory and enable a user to display the graphical representation at subsequent times.

In some examples, the first mobile computing device may detect a change in the position of the first mobile computing device from the first location and then establish a second wireless communication connection between the first mobile computing device and a third mobile computing device. In particular, a third mobile computing device is positioned at a third location that may serve as another base station for relative measurements. As such, the first mobile computing device may provide, on the display interface of the first mobile computing device, instructions to rotate the first mobile computing device until the orientation of the first mobile computing device aligns with an orientation of the third mobile computing device. The first mobile computing device can then determine a fourth location representing the position of the first mobile computing device relative to the third mobile computing device. The first mobile computing device determines the third location based on a second plurality of GNSS signals received by the first mobile computing device and second correction data provided by the third mobile computing device positioned at the third location. In practice, mobile computing devices can switch between various computing devices serving as base stations, which can enable a user to customize which distances are measured at a given time.

In some examples, the first mobile computing device may determine the orientation of the first mobile computing device matches the orientation of the second mobile computing device based on providing instructions to rotate the first mobile computing device. The first mobile computing device may then receive the plurality of GNSS signals and measurement data from the second mobile computing device within a threshold time in response to determining that the orientation of the first mobile computing device matches the orientation of the second mobile computing device. The threshold time can ensure that the orientations of the first and second mobile computing devices are aligned while the first mobile computing device uses data from the second computing device to determine its own location. In some cases, the first mobile computing device may then determine that the orientation of the first mobile computing device no longer matches the orientation of the second mobile computing device. The first mobile computing device may then provide an alert with subsequent instructions to rotate the first mobile computing device until the orientation of the first mobile computing device matches the orientation of the second mobile computing device.

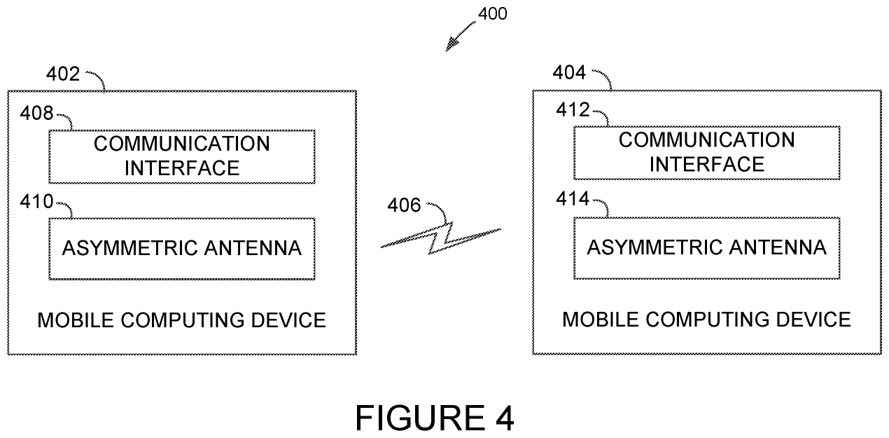

FIG. 4 is a simplified block-diagram of two mobile computing devices establishing a wireless communication connection. In particular, mobile computing device 402 and mobile computing device 404 are shown establishing wireless communication connection 406 that allows information to be exchanged between mobile computing device 402 and mobile computing device 404. In the example, mobile computing device 402 includes communication interface 408 and asymmetric antenna 410 and mobile computing device 404 similarly includes communication interface 412 and asymmetric antenna 414. Communication interfaces 408, 412 can be implemented similar to communication interface 106 of computing system 100 shown in FIG. 1. Asymmetric antennas 410, 414 can represent one or multiple asymmetric antennas that can be used for GNSS signal reception. An asymmetric antenna is an antenna design that has an unequal distribution of phase center depending on the direction of radiation or reception of the signal. In an asymmetric antenna, the radiation pattern is not symmetric with respect to a reference point or axis.

In general, mobile computing devices 402, 404 can use wireless communication connection 406 to exchange a variety of information, such as position and orientation information. For instance, mobile computing device 402 can receive data representing the orientation of mobile computing device 404 relative to a reference point (e.g., geographic north). The reference point can be used as a basis for measurement or comparison between mobile computing devices 402, 404.

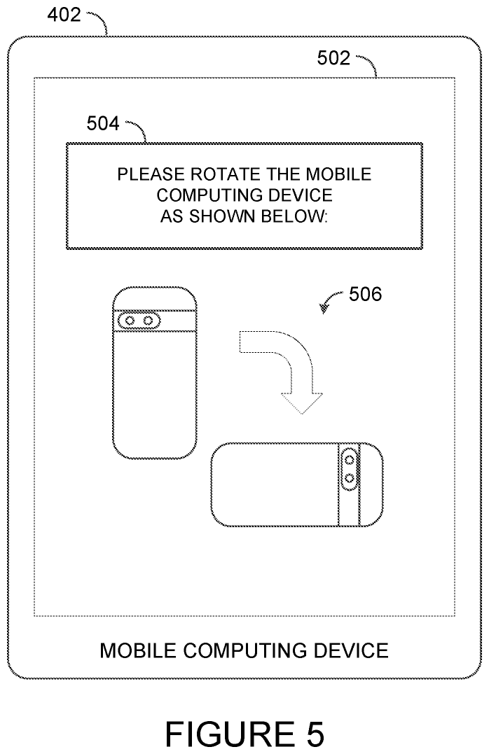

FIG. 5 shows mobile computing device 402 displaying rotation instructions 504. In particular, in the example shown in FIG. 5, mobile computing device 402 is displaying a graphical user interface on its screen 502 that provides rotation instructions 504 along with graphical representation 506 to inform a user to adjust the orientation to align mobile computing device 402 with the orientation of mobile computing device 404. In some examples, graphical representation 506 can involve a visual depiction or presentation of data, information, or concepts using graphical elements, such as diagrams or other visual aids. In practice, graphical representation 506 can visually communicate and convey user instructions in a more accessible and easily understandable format. In the example shown in FIG. 5, graphical representation 506 depicts a rotation of a mobile computing device that is used to represent mobile computing device 402.

In some examples, mobile computing device 402 can supplement visuals with audio instructions, alerts, and/or haptic feedback. For instance, mobile computing device 402 may provide a chime or ring that signals when mobile computing device 402 is aligned with the orientation of the mobile computing device serving as the base station or rover.

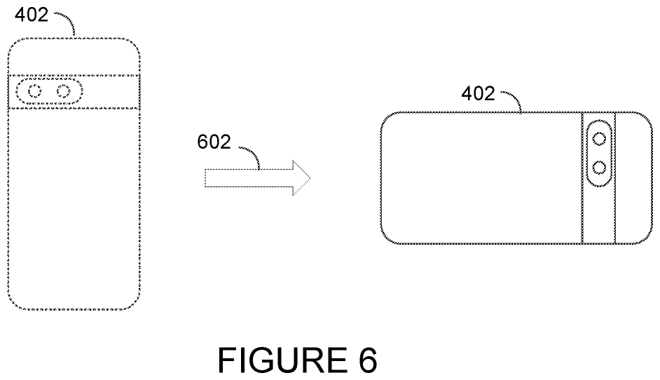

FIG. 6 illustrates adjusting the orientation of mobile computing device 402. In particular, a user may rotate mobile computing device 402 in accordance with rotation instructions 504 and graphical representation 506 displayed by mobile computing device 402. In the example, the rotation of mobile computing device 402 is represented by arrow 602. In some cases, the user may be prompted by mobile computing device 402 to rotate, flip, and/or adjust the orientation of mobile computing device 402 in other ways. In some examples, mobile computing device 402 can detect when its orientation matches the orientation of mobile computing device 404 and provide an audio, visual, and/or haptic alert in response. The alert can notify that the user can stop adjusting the orientation of mobile computing device 404.

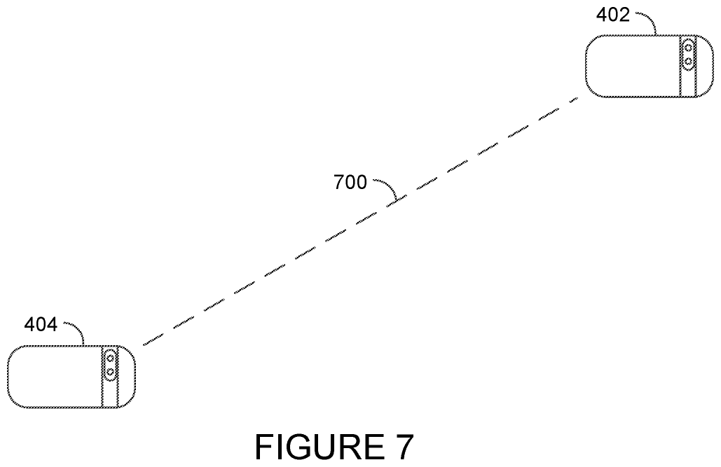

FIG. 7 depicts mobile computing device 402 and mobile computing device 404 performing localization measurements. In particular, mobile computing device 402 is shown determining its location relative to mobile computing device 404 (represented by dotted line 700), which can convey distance, azimuth, and elevation measurements. Mobile computing device 402 and mobile computing device 404 may use one or more asymmetric antennas 410, 414, respectively, to receive the GNSS signals while also engaging in sharing information over an established wireless communication connection to enable RTK localization measurements. In the example shown in FIG. 7, mobile computing device 402 can serve as the base station or rover while mobile computing device 404 serves as the other.

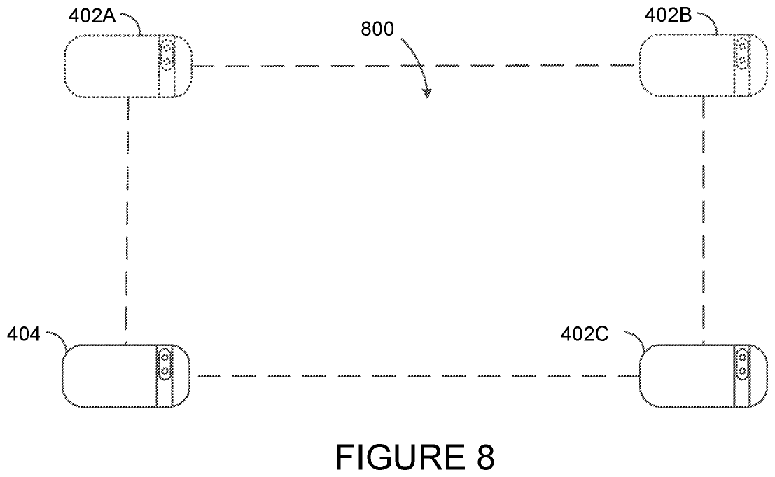

FIG. 8 illustrates mobile computing device 402 and mobile computing device 404 mapping an area. In particular, mobile computing device 402 and/or mobile computing device 404 can determine area 800 based on multiple positions (position 402A, position 402B, and position 402C) of mobile computing device 402 measured relative to mobile computing device 404. Area 800 can be stored and subsequently reviewed by users of mobile computing device 402. 404. In addition, each mobile computing device 402 can display a representation of the environment with a graphic overlay visually representing area 800. For instance, disclosed techniques can be used to map a soccer or football field, which can be subsequently be painted based on the representation of the environment with the graphic overlay visually representing area 800.

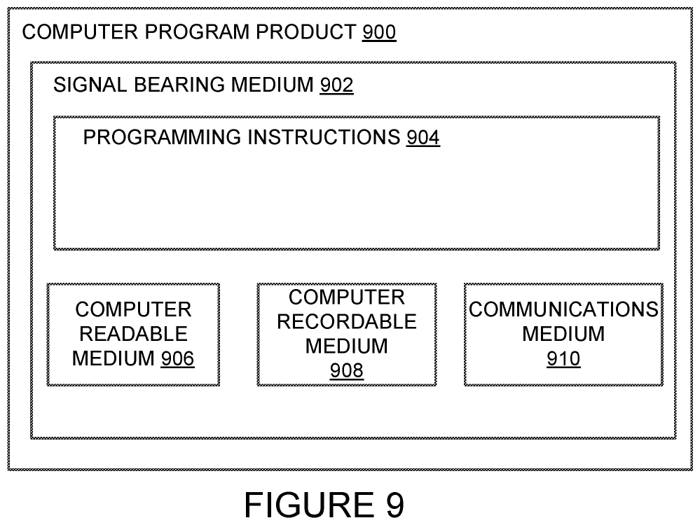

FIG. 9 is a schematic illustrating a conceptual partial view of an example computer program product that includes a computer program for executing a computer process on a computing device, arranged according to at least some embodiments presented herein. one embodiment, computer program product 900 is provided using signal bearing medium 902.

Signal bearing medium 902 may include one or more programming instructions 904 that, when executed by one or more processors may provide functionality or portions of the functionality described above with respect to FIGS. 1-8. In some examples, signal bearing medium 902 may encompass computer-readable medium 906, such as, but not limited to, a hard disk drive, a Compact Disc (CD), a Digital Video Disk (DVD), a digital tape, memory, etc.

In some implementations, signal bearing medium 902 may encompass a computer recordable medium 908, such as, but not limited to, memory, read/write (R/W) CDs. R/W DVDs, etc. Signal bearing medium 902 may encompass a communications medium 910, such as, but not limited to, a digital and/or an analog communication medium (e.g., a fiber optic cable, a waveguide, a wired communications link, a wireless communication link, etc.). Thus, for example, signal bearing medium 902 may be conveyed by a wireless form of communications medium 910.

Programming instructions 904 may be, for example, computer executable and/or logic implemented instructions. In some examples, a computing device such as processor 102 of FIG. 1 may be configured to provide various operations, functions, or actions in response to the programming instructions 904 conveyed to processor 102 by one or more of computer-readable medium 906, computer recordable medium 908, and/or communications medium 910.

The non-transitory computer readable medium could also be distributed among multiple data storage elements, which could be remotely located from each other. The computing device that executes some or all of the stored instructions could be a device, such as computing system 100 illustrated in FIG. 1 or mobile computing device 202 illustrated in FIG. 2. Alternatively, the computing device that executes some or all of the stored instructions could be another computing device, such as a server.

It should be understood that arrangements described herein are for purposes of example only. As such, those skilled in the art will appreciate that other arrangements and other elements (e.g. machines, interfaces, functions, orders, and groupings of functions, etc.) can be used instead, and some elements may be omitted altogether according to the desired results. Further, many of the elements that are described are functional entities that may be implemented as discrete or distributed components or in conjunction with other components, in any suitable combination and location.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims, along with the full scope of equivalents to which such claims are entitled. It is also to be understood that the terminology used herein is for the purpose of describing particular embodiments only, and is not intended to be limiting.

Since many modifications, variations, and changes in detail can be made to the described example, it is intended that all matters in the preceding description and shown in the accompanying figures be interpreted as illustrative and not in a limiting sense.

What is claimed is:

1. A method comprising:
establishing, by a first mobile computing device, a wireless communication connection with a second mobile computing device;
receiving, at the first mobile computing device and from the second mobile computing device, data representing an orientation of the second mobile computing device relative to a reference point;
providing, by the first mobile computing device and on a display interface of the first mobile computing device, instructions to rotate the first mobile computing device until an orientation of the first mobile computing device matches the orientation of the second mobile computing device;
receiving, by the first mobile computing device, a plurality of Global Navigation Satellite System (GNSS) signals and measurement data from the second mobile computing device positioned at a second location; and
determining, by the first mobile computing device, a first location representing a position of the first mobile computing device relative to the second mobile computing device based on the plurality of GNSS signals and the measurement data received from the second mobile computing device.

2. The method of claim 1, wherein both the first mobile computing device and the second mobile computing device include one or more asymmetric antennas configured for receiving GNSS signals.

3. The method of claim 2, further comprising:
receiving, at the first mobile computing device using one or more asymmetric antennas, the plurality of GNSS signals.

4. The method of claim 1, wherein determining the first location representing the position of the first mobile computing device comprises:
determining the first location representing the position of the first mobile computing device at a centimeter-level relative to the second location of the second mobile computing device.

5. The method of claim 1, further comprising:
receiving data representing an absolute location of the second mobile computing device; and
wherein determining the first location representing the position of the first mobile computing device comprises:
determining an absolute location of the first mobile computing device, wherein the absolute location of the first mobile computing device indicates a longitude, a latitude, and an elevation of the first mobile computing device.

6. The method of claim 1, wherein determining the first location representing the position of the first mobile computing device relative to the second mobile computing device comprises:
determining a distance, an azimuth, and an elevation of the first mobile computing device relative to the second mobile computing device.

7. The method of claim 1, further comprising:
based on providing instructions to rotate the first mobile computing device, determining the orientation of the first mobile computing device matches the orientation of the second mobile computing device; and
wherein receiving the plurality of GNSS signals and measurement data from the second mobile computing device comprises:
receiving the plurality of GNSS signals and measurement data from the second mobile computing device within a threshold time in response to determining the orientation of the first mobile computing device matches the orientation of the second mobile computing device.

8. The method of claim 7, further comprising:
determining that the orientation of the first mobile computing device no longer matches the orientation of the second mobile computing device; and
provide an alert with subsequent instructions to rotate the first mobile computing device until the orientation of the first mobile computing device matches the orientation of the second mobile computing device.

9. The method of claim 1, wherein the first mobile computing device and the second mobile computing device are complementary models of mobile computing devices.

10. The method of claim 1, wherein receiving data representing the orientation of the second mobile computing device relative to the reference point comprises:
receiving data representing the orientation of the second mobile computing device relative to a geographic north direction.

11. The method of claim 10, wherein determining the orientation of the first mobile computing device comprises:
determining the orientation based on sensor data from a magnetometer of the first mobile computing device.

12. The method of claim 1, further comprising:
detecting, at the first mobile computing device, a change in the position of the first mobile computing device; and
determining, by the first mobile computing device, a third location representing the position of the first mobile computing device, wherein the first mobile computing device determines the third location based on a second plurality of GNSS signals received by the first mobile computing device and additional measurement data received from the second mobile computing device positioned at the second location.

13. The method of claim 12, further comprising:
estimating an area of an environment extending between the first location, the second location, and the third location.

14. The method of claim 1, further comprising:
detecting a change in position of the first mobile computing device from the first location;
establishing a second wireless communication connection between the first mobile computing device and a third mobile computing device, wherein the third mobile computing device is positioned at a third location;
providing, by the first mobile computing device and on the display interface of the first mobile computing device, instructions to rotate the first mobile computing device until the orientation of the first mobile computing device matches an orientation of the third mobile computing device; and
determining, by the first mobile computing device, a fourth location representing the position of the first mobile computing device relative to the third mobile computing device, wherein the first mobile computing device determines the third location based on a second plurality of GNSS signals received by the first mobile computing device and second correction data provided by the third mobile computing device positioned at the third location.

15. A system comprising:
a first mobile computing device and a second mobile computing device, wherein the first mobile computing device is configured to:
establish a wireless communication connection with the second mobile computing device;
receive, from the second mobile computing device, data representing an orientation of the second mobile computing device relative to a reference point;
provide, on a display interface of the first mobile computing device, instructions to rotate the first mobile computing device until an orientation of the first mobile computing device matches the orientation of the second mobile computing device;
receive a plurality of Global Navigation Satellite System (GNSS) signals and measurement data from the second mobile computing device positioned at a second location; and
determine a first location representing a position of the first mobile computing device relative to the second mobile computing device based on the plurality of GNSS signals and the measurement data received from the second mobile computing device.

16. The system of claim 15, wherein the first mobile computing device is further configured to:
determine an elevation difference between the first mobile computing device and the second mobile computing device.

17. The system of claim 15, wherein the first mobile computing device is further configured to:
receive the measurement data from the second mobile computing device via the wireless communication connection.

18. The system of claim 15, wherein the first mobile computing device is further configured to:
store the first location representing the position of the first mobile computing device relative to the second mobile computing device;
determine, based on the first location and one or more additional locations representing respective positions of the first mobile computing device relative to the second mobile computing device, an area of an environment; and
displaying an augmented map of the environment with an overlay representing the area of the environment.

19. The system of claim 15, wherein the first mobile computing device is further configured to:
detect the orientation of the first mobile computing device matches the orientation of the second mobile computing device; and
provide an audio, visual, or haptic alert based on detecting the orientation of the first mobile computing device matches the orientation of the second mobile computing device.

20. A non-transitory computer readable medium configured to store instructions, that when executed by a first mobile computing device, causes the first mobile computing device to perform operations comprising:
establishing a wireless communication connection with a second mobile computing device;
receiving, from the second mobile computing device, data representing an orientation of the second mobile computing device relative to a reference point;
providing, on a display interface of the first mobile computing device, instructions to rotate the first mobile computing device until an orientation of the first mobile computing device matches the orientation of the second mobile computing device;
receiving a plurality of Global Navigation Satellite System (GNSS) signals and measurement data from the second mobile computing device positioned at a second location; and
determining a first location representing a position of the first mobile computing device relative to the second mobile computing device based on the plurality of GNSS signals received by the first mobile computing device and the measurement data received from the second mobile computing device.
